(19) United States
(12) Patent Application Publication
(10) Pub. No.: US 2021/0323524 A1
(43) Pub. Date: Oct. 21, 2021

(54) OPERATING METHOD OF ELECTRONIC BRAKE SYSTEM

(71) Applicant: MANDO CORPORATION, Pyeongtaek-si (KR)

(72) Inventor: Seungkuk LIM, Seoul (KR)

(21) Appl. No.: 17/232,427

(22) Filed: Apr. 16, 2021

(30) Foreign Application Priority Data
Apr. 16, 2020 (KR) 10-2020-0046039

(51) Int. Cl. B60T 13/68; B60T 13/74; B60T 7/04; B60T 7/06

(52) U.S. Cl. CPC B60T 13/686; B60T 7/06; B60T 7/042; B60T 13/745

(57) ABSTRACT

Disclosed is an operating method of an electronic brake system including a hydraulic pressure supply device configured to generate a hydraulic pressure for braking of a wheel cylinder by operating a hydraulic piston by an electrical signal output in response to a displacement of a brake pedal, a reservoir in which a pressurization medium is stored, a dump controller configured to control a flow of the pressurization medium between the reservoir and the hydraulic pressure supply device, and a hydraulic control unit provided between the hydraulic pressure supply device and the wheel cylinder, wherein the hydraulic pressure supply device includes a first pressure chamber provided on a front side of the hydraulic piston and a second pressure chamber provided on a rear side of the hydraulic piston, and wherein the operating method includes a first braking mode in which the hydraulic piston moves forward to firstly provide the hydraulic pressure formed in the first pressure chamber to the wheel cylinder, a second braking mode in which the hydraulic piston additionally moves forward to secondly provide at least a part of the hydraulic pressure formed in the first pressure chamber to the wheel cylinder and provide the remaining part of the hydraulic pressure formed in the first pressure chamber to the second pressure chamber, and a third braking mode in which the hydraulic piston moves backward to thirdly provide the hydraulic pressure formed in the second pressure chamber to the wheel cylinder.

### CROSS-REFERENCE TO RELATED APPLICATION(S)

This application is based on and claims priority under 35 U.S.C. § 119 to Korean Patent Application No. 10-2020-0046039, filed on Apr. 16, 2020, in the Korean Intellectual Property Office, the disclosure of which is incorporated by reference herein in its entirety.

### BACKGROUND

### 1. Field

The disclosure relates to an operating method of an electronic brake system, and more particularly, to an operating method of an electronic brake system for generating a braking force using an electrical signal corresponding to a displacement of a brake pedal.

### 2. Description of the Related Art

Vehicles are essentially equipped with a brake system for performing braking, and various types of brake systems have been proposed for the safety of drivers and passengers.

In a conventional brake system, a method of supplying a hydraulic pressure required for braking to wheel cylinders using a mechanically connected booster when a driver depresses a brake pedal has been mainly used. However, as market demands to implement various braking functions in detail in response to operating environments of vehicles increase, in recent years, an electronic brake system, which receives an electrical signal corresponding to the braking force of a driver from a pedal displacement sensor that senses a displacement of a brake pedal when the driver depresses the brake pedal and supplies a hydraulic pressure required for braking to wheel cylinders by actuating a hydraulic pressure supply device based on thereon, has been widely used.

Such an electronic brake system receives an electric signal generated as a braking operation when a driver depresses a brake pedal or when a vehicle is autonomously driven in a normal operation mode, and electrically operates and controls a hydraulic pressure supply device based thereon, thereby generating a hydraulic pressure required for braking and transferring the hydraulic pressure to wheel cylinders. Because such an electronic brake system is electrically operated and controlled, complex and various braking actions may be implemented.

European Patent Publication No. EP 2 520 473 A1 (Honda Motor Co., Ltd.) has been published on Nov. 7, 2012 as an example of a conventional electronic brake system.

### SUMMARY

It is an aspect of the disclosure to provide an operating method of an electronic brake system capable of stably providing a hydraulic pressure of a pressurization medium for braking a vehicle.

It is an aspect of the disclosure to provide an operating method of an electronic brake system capable of stably generating a high braking pressure.

It is an aspect of the disclosure to provide an operating method of an electronic brake system capable of effectively performing braking even in various operating situations of a vehicle.

It is an aspect of the disclosure to provide an operating method of an electronic brake system with improved braking performance and operational reliability.

It is an aspect of the disclosure to provide an operating method of an electronic brake system capable of improving durability of a product by reducing loads applied to components.

Additional aspects of the disclosure will be set forth in part in the description which follows and, in part, will be obvious from the description, or may be learned by practice of the disclosure.

In accordance with an aspect of the disclosure, an operating method of an electronic brake system includes a hydraulic pressure supply device configured to generate a hydraulic pressure for braking of a wheel cylinder by operating a hydraulic piston by an electrical signal output in response to a displacement of a brake pedal, a reservoir in which a pressurization medium is stored, a dump controller configured to control a flow of the pressurization medium between the reservoir and the hydraulic pressure supply device, and a hydraulic control unit provided between the hydraulic pressure supply device and the wheel cylinder, wherein the hydraulic pressure supply device includes a first pressure chamber provided on a front side of the hydraulic piston and a second pressure chamber provided on a rear side of the hydraulic piston, and wherein the operating method includes a first braking mode in which the hydraulic piston moves forward to firstly provide the hydraulic pressure formed in the first pressure chamber to the wheel cylinder, a second braking mode in which the hydraulic piston additionally moves forward to secondly provide at least a part of the hydraulic pressure formed in the first pressure chamber to the wheel cylinder and provide the remaining part of the hydraulic pressure formed in the first pressure chamber to the second pressure chamber, and a third braking mode in which the hydraulic piston moves backward to thirdly provide the hydraulic pressure formed in the second pressure chamber to the wheel cylinder.

The hydraulic control unit may include a first hydraulic flow path having one end in communication with the first pressure chamber, a second hydraulic flow path having one end in communication with the second pressure chamber, a third hydraulic flow path to join the other end of the first hydraulic flow path and the other end of the second hydraulic flow path and connected to the wheel cylinder, a first valve provided in the first hydraulic flow path, and a second valve provided in the second hydraulic flow path, and in the first braking mode, the first valve may be opened and the second valve may be closed so that the hydraulic pressure formed in the first pressure chamber is provided to the wheel cylinder through the first hydraulic flow path and the third hydraulic flow path.

The hydraulic control unit may include a first hydraulic flow path having one end in communication with the first pressure chamber, a second hydraulic flow path having one end in communication with the second pressure chamber, a third hydraulic flow path to join the other end of the first hydraulic flow path and the other end of the second hydraulic flow path and connected to the wheel cylinder, a first valve provided in the first hydraulic flow path, and a second valve provided in the second hydraulic flow path, and in the second braking mode, the first valve and the second valve may be opened so that at least a part of the hydraulic pressure formed in the first pressure chamber is provided to the wheel cylinder through the first hydraulic flow path and the third hydraulic flow path and the remaining part of the hydraulic pressure formed in the first pressure chamber is provided to the second pressure chamber through the first hydraulic flow path and the second hydraulic flow path.

The hydraulic control unit may include a first hydraulic flow path having one end in communication with the first pressure chamber, a second hydraulic flow path having one end in communication with the second pressure chamber, a third hydraulic flow path to join the other end of the first hydraulic flow path and the other end of the second hydraulic flow path and connected to the wheel cylinder, a first valve provided in the first hydraulic flow path, and a second valve provided in the second hydraulic flow path, and in the third braking mode, the second valve may be opened and the first valve may be closed so that the hydraulic pressure formed in the second pressure chamber is provided to the wheel cylinder through the second hydraulic flow path and the third hydraulic flow path.

The dump controller may include a first dump flow path to connect the reservoir and the first pressure chamber, a second dump flow path to connect the reservoir and the second pressure chamber, and a dump valve provided in the second dump flow path, and in the first braking mode, the dump valve may be opened so that the pressurization medium is supplied from the reservoir to the second pressure chamber.

The dump controller may include a first dump flow path to connect the reservoir and the first pressure chamber, a second dump flow path to connect the reservoir and the second pressure chamber, and a dump valve provided in the second dump flow path, and in the second braking mode, the dump valve may be closed so that a negative pressure is formed in the second pressure chamber.

The dump controller may include a first dump flow path to connect the reservoir and the first pressure chamber, a second dump flow path to connect the reservoir and the second pressure chamber, and a dump valve provided in the second dump flow path, and in the third braking mode, the dump valve may be closed so that the hydraulic pressure formed in the second pressure chamber is blocked from leaking into the reservoir.

The dump controller may further include a dump check valve provided in the first dump flow path, and in the first braking mode, the dump check valve may block the hydraulic pressure formed in the first pressure chamber from leaking into the reservoir.

The dump controller may further include a dump check valve provided in the first dump flow path, and in the second braking mode, the dump check valve may block the hydraulic pressure formed in the first pressure chamber from leaking into the reservoir.

The dump controller may further include a dump check valve provided in the first dump flow path, and in the third braking mode, the dump check valve may allow supply of the pressurization medium from the reservoir to the first pressure chamber.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a hydraulic circuit diagram illustrating an electronic brake system according to the present embodiment;

FIG. 2 is a hydraulic circuit diagram illustrating an operation in which the electronic brake system according to the present embodiment performs a first braking mode;

FIG. 3 is a graph illustrating a change in hydraulic pressure of a pressurization medium to be transmitted to a wheel cylinder depending on a displacement amount of a hydraulic piston in the first braking mode;

FIG. 4 is a hydraulic circuit diagram illustrating an operation in which the electronic brake system according to the present embodiment performs a second braking mode;

FIG. 5 is a graph illustrating a change in hydraulic pressure of the pressurization medium to be transmitted to the wheel cylinder depending on a displacement amount of the hydraulic piston in the second braking mode;

FIG. 6 is a hydraulic circuit diagram illustrating an operation in which the electronic brake system according to the present embodiment performs a third braking mode; and

FIG. 7 is a graph illustrating a change in hydraulic pressure of the pressurization medium to be transmitted to the wheel cylinder depending on a displacement amount of the hydraulic piston in the third braking mode.

### DETAILED DESCRIPTION

Hereinafter, embodiments of the present disclosure will be described in detail with reference to the accompanying drawings. The following embodiments are provided as examples to fully convey the spirit of the present disclosure to a person having ordinary skill in the art to which the present disclosure belongs. The present disclosure is not limited to the embodiments shown herein but may be embodied in other forms. In order to clearly explain the present invention, parts not related to the description are omitted from the drawings, and the width, length, thickness, etc. of the components may be exaggerated for convenience.

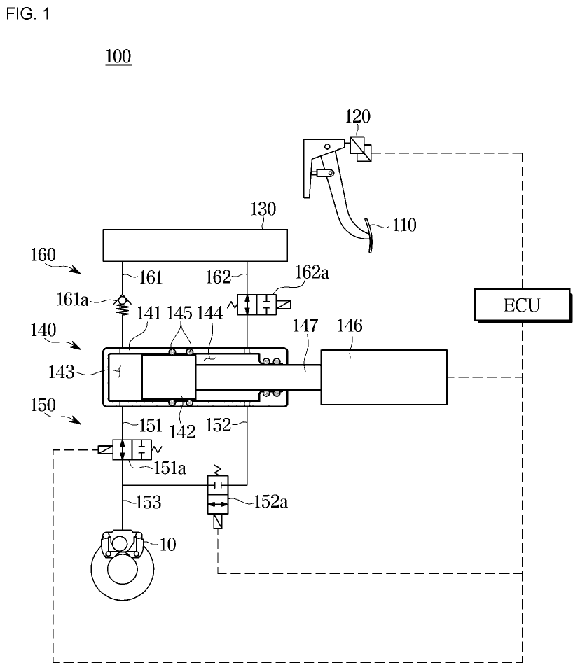

FIG. 1 is a hydraulic circuit diagram illustrating an electronic brake system 100 according to the present embodiment.

Referring to FIG. 1, the electronic brake system 100 according to the present embodiment includes a reservoir 130 in which a pressurization medium is stored, a hydraulic pressure supply device 140 to receive an electrical signal corresponding to a braking force of a driver from a pedal displacement sensor 120 that senses a displacement of a brake pedal 110 and generate a hydraulic pressure of the pressurization medium through a mechanical operation, a hydraulic control unit 150 to control the hydraulic pressure provided from the hydraulic pressure supply device 140, a dump controller 160 disposed between the hydraulic pressure supply device 140 and the reservoir 130 to control a flow of the pressurization medium, and an electronic control unit (ECU) to control the hydraulic pressure supply device 140 and various valves based on hydraulic pressure information and pedal displacement information.

When the driver depresses the brake pedal 110 in order to brake a vehicle, the brake pedal 110 is connected to a master cylinder (not shown) or a pedal simulator (not shown) to provide a sense of pedal effort to the driver, and at the same time the pressurization medium accommodated in the master cylinder in an emergency such as a fallback mode is transferred to a wheel cylinder 10, so that emergency braking of the vehicle may be performed. However, in a normal operating state of the electronic brake system 100, the pedal displacement sensor 120 detects a displacement of the brake pedal 110 generated when the driver depresses the brake pedal 110, and the electronic control unit transmits an electrical signal corresponding to the displacement of the brake pedal 110 to the hydraulic pressure supply device 140, so that the hydraulic pressure of the pressurization medium may be generated through a mechanical operation.

The hydraulic pressure supply device 140 includes a cylinder block 141, a hydraulic piston 142 accommodated in the cylinder block 141, a sealing member 145 provided between the hydraulic piston 142 and the cylinder block 140 to seal pressure chambers 143 and 144, an actuator 146 to generate and provide power for the forward and backward movement of the hydraulic piston 142, and a drive shaft 147 to transmit the power generated and provided by the actuator 146 to the hydraulic piston 142.

The pressure chambers 143 and 144 may include the first pressure chamber 143 positioned in the front of the hydraulic piston 142 (the left direction of the hydraulic piston 142 based on FIG. 1), and the second pressure chamber 144 positioned in the rear of the hydraulic piston 142 (the right direction of the hydraulic piston 142 based on FIG. 1). That is, the first pressure chamber 143 is provided to be partitioned by the cylinder block 141 and a front surface of the hydraulic piston 142 so that the volume thereof varies according to the movement of the hydraulic piston 142, and the second pressure chamber 144 is provided to be partitioned by the cylinder block 141 and a rear surface of the hydraulic piston 142 so that the volume thereof varies depending on the movement of the hydraulic piston 142.

The actuator 146 is configured to generate and provide the power of the hydraulic piston 142 by an electrical signal output from the electronic control unit (ECU). The actuator 146 may include a motor (not shown) and a power conversion device (not shown), and the drive shaft 147 is provided between the hydraulic piston 142 and the actuator 146 so that the power generated by the actuator 146 may be transmitted to the hydraulic piston 142 through the drive shaft 147. The hydraulic piston 142 may move forward or backward by rotating the motor in the forward or reverse direction. The actuator 146 for generating power and providing the power to the hydraulic piston 142 is a well-known technology, and thus a detailed description thereof will be omitted.

By the operation of the hydraulic piston 142, a hydraulic pressure of the pressurization medium or a negative pressure may be generated in the first pressure chamber 143 and the second pressure chamber 144. Specifically, the motor rotates in one direction by receiving an electrical signal from the electronic control unit, and a rotational force of the motor may move the hydraulic piston 142 forward in the cylinder block 141 through the drive shaft 147. As the hydraulic piston 142 moves forward, the volume of the first pressure chamber 143 decreases, and thus the hydraulic pressure of the pressurization medium accommodated in the first pressure chamber 143 may be generated.

Conversely, when the motor rotates in the other direction by receiving an electrical signal from the electronic control unit, the rotational force of the motor may move the hydraulic piston 142 backward in the cylinder block 141 through the drive shaft 147. As the hydraulic piston 142 moves backward, the volume of the first pressure chamber 143 increases, and thus the negative pressure may be generated in the first pressure chamber 143.

The hydraulic pressure and negative pressure in the second pressure chamber 144 may be generated by operating in a direction opposite to the above-described direction. That is, the motor rotates in the other direction by receiving an electrical signal from the electronic control unit, and thus the hydraulic piston 142 may move backward in the cylinder block 141. As the hydraulic piston 142 moves backward, the volume of the second pressure chamber 144 decreases, and thus the hydraulic pressure of the pressurization medium accommodated in the second pressure chamber 144 may be generated.

Conversely, when the motor rotates in one direction by receiving an electrical signal from the electronic control unit, the rotational force of the motor may move the hydraulic piston 142 forward in the cylinder block 141 through the drive shaft 147. As the hydraulic piston 142 moves forward, the volume of the second pressure chamber 144 increases, and thus the negative pressure may be generated in the second pressure chamber 144.

As such, the hydraulic pressure supply device 140 may generate a hydraulic pressure and a negative pressure in the first pressure chamber 143 and the second pressure chamber 144, respectively, depending on the driving direction of the motor of the actuator 146, and whether the braking of the wheel cylinder 10 is to be performed by transferring the hydraulic pressure, or whether the braking of the wheel cylinder 10 is to be released using the negative pressure may be determined by controlling valves.

The hydraulic pressure supply device 140 may be hydraulically connected to the reservoir 130 by the dump controller 160. The reservoir 130 is provided to accommodate the pressurization medium therein, and the first and second pressure chambers 143 and 144 of the hydraulic pressure supply device 140 receive the pressurization medium from the reservoir 130 through the dump controller 160, or, conversely, the pressurization medium accommodated in the first and second pressure chambers 143 and 144 may be transferred to the reservoir 130 through the dump controller 160. The dump controller 160 may include a first dump flow path 161 to connect the first pressure chamber 143 and the reservoir 130, a second dump flow path 162 to connect the second pressure chamber 144 and the reservoir 130, a dump check valve 161a provided in the first dump flow path 161 to control the flow of the pressurization medium such that only a flow of the pressurization medium from the reservoir 130 to the first pressure chamber 143 is allowed, and a dump valve 162a provided in the second dump flow path 162 to control the flow of the pressurization medium in both directions.

The first dump flow path 161 may have one end in communication with the reservoir 130 and the other end in communication with the first pressure chamber 143, and the dump check valve 161a may be provided to allow the flow of the pressurization medium from the reservoir 130 to the first pressure chamber 143 but block the flow of the pressurization medium from the first pressure chamber 143 to the reservoir 130. The second dump flow path 162 may have one end in communication with the reservoir 130 and the other end in communication with the second pressure chamber 144. The dump valve 162a disposed in the second dump flow path 162 may be provided as a normally open type solenoid valve that operates to be closed when a closing signal is received from the electronic control unit in a normally open state.

The dump controller 160 may control the flow of the pressurization medium between the first and second pressure chambers 143 and 144 of the hydraulic pressure supply device 140 and the reservoir 130, thereby performing efficient operation of the hydraulic pressure supply device 140 in first to third braking modes. A detailed description thereto will be described later.

The hydraulic control unit 150 is provided between the hydraulic pressure supply device 140 and the wheel cylinder 10 to control the hydraulic pressure of the pressurization medium to be transmitted to the wheel cylinder 10 or control the flow of the pressurization medium between the first pressure chamber 143 and the second pressure chamber 144 of the hydraulic pressure supply device 140.

The hydraulic control unit 150 may include a first hydraulic flow path 151 in communication with the first pressure chamber 143, a second hydraulic flow path 152 in communication with the second pressure chamber 144, a third hydraulic flow path 153 to join the first hydraulic flow path 151 and the second hydraulic flow path 152 and connected to the wheel cylinder 10, a first valve 151a provided in the first hydraulic flow path 151 to control the flow of the pressurization medium, and a second valve 152a provided in the second hydraulic flow path 152 to control the flow of the pressurization medium.

The first hydraulic flow path 151 is provided such that one end thereof is in communication with the first pressure chamber 143, and the second hydraulic flow path 152 is provided such that one end thereof is in communication with the second pressure chamber 144. The other ends of the first hydraulic flow path 151 and the second hydraulic flow path 153 may join each other and be connected to one end of the third hydraulic flow path 153, and the other end of the third hydraulic flow path 153 may be connected to the wheel cylinder 10.

The first valve 151a to control the flow of the pressurization medium may be provided in the first hydraulic flow path 151. The first valve 151a may be provided as a two-way control valve that controls the flow of the pressurization medium to be transmitted along the first hydraulic flow path 151. FIG. 1 illustrates that the first valve 151a is provided as a normally open type solenoid valve that operates to be closed when an electrical signal is received from the electronic control unit in a normally open state, but the first valve 151a may be provided as a normally dosed type solenoid valve, as long as the first valve 151a may operate by receiving an electrical signal to control the flow of the pressurization medium in both directions.

The second valve 152a to control the flow of the pressurization medium may be provided in the second hydraulic flow path 152. The second valve 152a may be provided as a two-way control valve that controls the flow of the pressurization medium to be transmitted along the second hydraulic flow path 152. The second valve 152a may be provided as a normally closed type solenoid valve that operates to be opened when an electrical signal is received from the electronic control unit in a normally closed state but is limited thereto. That is, the second valve 152a may be provided as a normally open type solenoid valve, as long as the second valve 152a may operate by receiving an electrical signal to control the flow of the pressurization medium in both directions.

Hereinafter, a method of operating the electronic brake system 100 according to the present embodiment will be described.

The electronic brake system 100 according to the present embodiment may operate in the first braking mode, the second braking mode, and the third braking mode as the hydraulic pressure transmitted from the hydraulic pressure supply device 140 to the wheel cylinder 10 increases.

The first to third braking modes may be implemented by controlling the operation of the hydraulic pressure supply device 140, the hydraulic control unit 150, and the dump controller 160. The hydraulic pressure supply device 140 may provide a sufficiently high hydraulic pressure of the pressurization medium without a high-end motor by utilizing the first to third braking modes and may prevent an unnecessary load applied to the motor. Furthermore, when the braking mode is sequentially switched from the first braking mode to the third braking mode according to the increase in hydraulic pressure, the hydraulic pressure supply device 140 may stably and effectively increase the hydraulic pressure of the pressurization medium provided to the wheel cylinder 10 without delaying the pressurization. Accordingly, a stable braking force may be secured while reducing the cost and weight of the brake system, and durability and operational reliability of components may be improved.

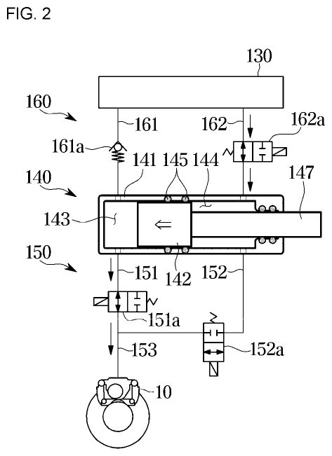

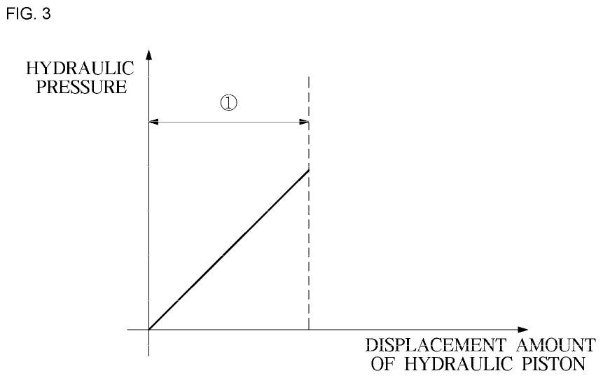

FIG. 2 is a hydraulic circuit diagram illustrating an operation in which the electronic brake system 100 according to the present embodiment performs the first braking mode, and FIG. 3 is a graph illustrating a change in hydraulic pressure of the pressurization medium to be transmitted to the wheel cylinder 10 depending on a displacement amount of the hydraulic piston 142 in the first braking mode.

Referring to FIGS. 2 and 3, in the first braking mode, the electronic control unit drives the motor in one direction to move the hydraulic piston 142 forward. As the hydraulic piston 142 moves forward from its initial position, that is, as the stroke or displacement of the hydraulic piston 142 increases, the volume of the first pressure chamber 143 decreases. Accordingly, the hydraulic pressure of the pressurization medium formed in the first pressure chamber 143 increases, and furthermore, the hydraulic pressure of the pressurization medium provided to the wheel cylinder 10 also gradually increases (section \textcircled{1} in FIG. 3).

The hydraulic pressure of the pressurization medium formed in the first pressure chamber 143 is firstly transmitted to the wheel cylinder 10 by sequentially passing through the first hydraulic flow path 151 and the third hydraulic flow path 153. At this time, the first valve 151a provided in the first hydraulic flow path 151 is controlled to be in the open state to allow the flow of the pressurization medium, and the second valve 152a provided in the second hydraulic flow path 152 is controlled to be in the dosed state. Accordingly, the hydraulic pressure of the pressurization medium discharged from the first pressure chamber 143 is prevented from leaking into the second pressure chamber 144 through the second hydraulic flow path 152, so that a pressure increase rate per displacement (stroke) of the hydraulic piston 142 may be improved. Therefore, in the first braking mode, which is an initial braking period, a quick braking response may be implemented.

In addition, in the first braking mode, the dump valve 162a provided in the second dump flow path 162 is controlled to be in the open state to allow the flow of the pressurization medium through the second dump flow path 162. As the hydraulic piston 142 moves forward, the volume of the second pressure chamber 144 increases to form a negative pressure, and thus the pressurization medium accommodated in the reservoir 130 may be introduced into the second pressure chamber 144 through the second dump flow path 162 by the negative pressure.

In a case where a higher braking hydraulic pressure is required to be provided to the wheel cylinder 10 after the hydraulic piston 142 moves forward and firstly provides the hydraulic pressure to the wheel cylinder 10, the hydraulic piston 142 moved forward may move backward so that the pressurization medium accommodated in the second pressure chamber 144 forms the hydraulic pressure, thereby providing additional hydraulic pressure to the wheel cylinder 10. At this time, when the direction is changed so that the hydraulic piston 143 moved forward moves backward, in a case where an internal hydraulic pressure value of the second pressure chamber 144 and a hydraulic pressure value of the pressurization medium already applied to the wheel cylinder 10 do not coincide with each other, there is a risk that the hydraulic pressure of the pressurization medium applied to the wheel cylinder 10 momentarily decreases and the braking force is released. In addition, even in a case where a hydraulic flow path in communication with the first pressure chamber 143 is to be opened in order to synchronize the internal hydraulic pressure value of the second pressure chamber 144 with an internal hydraulic pressure value of the first pressure chamber 143 or the hydraulic pressure value applied to the wheel cylinder 10, the volume of the pressurization medium may increase so that the hydraulic pressure of the pressurization medium applied to the wheel cylinder 10 momentarily decreases, thereby causing a delay in the pressurization of the pressurization medium.

Accordingly, as a method of operating the electronic brake system 100 according to the present embodiment, before performing the third braking mode in which the hydraulic piston 143 moves backward to provide a high braking pressure after performing the first braking mode in which the hydraulic piston 142 moves forward to firstly provide the hydraulic pressure to the wheel cylinder 10, the electronic brake system 100 may perform the second braking mode to prevent a delay in pressurization of the pressurization medium and to continuously and stably increase the hydraulic pressure of the pressurization medium.

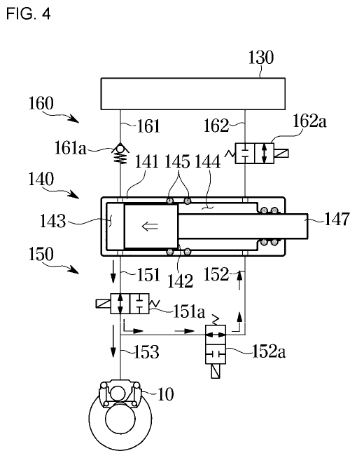

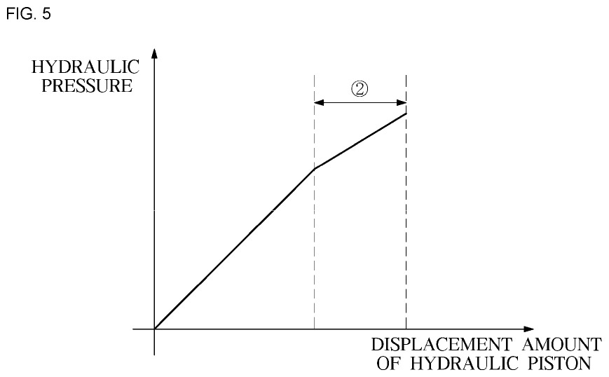

FIG. 4 is a hydraulic circuit diagram illustrating an operation in which the electronic brake system 100 according to the present embodiment performs the second braking mode, and FIG. 5 is a graph illustrating a change in hydraulic pressure of the pressurization medium to be transmitted to the wheel cylinder 10 depending on a displacement amount of the hydraulic piston 142 in the second braking mode.

Referring to FIGS. 4 and 5, the electronic control unit may control the operation of the hydraulic pressure supply device 140, the hydraulic control unit 150, and the dump controller 160 to enter the second braking mode after performing the first braking mode. Specifically, in the second braking mode, the electronic control unit additionally drives the motor in one direction to additionally move the hydraulic piston 142 forward. As the hydraulic piston 142 additionally moves forward after the first braking mode, the volume of the first pressure chamber 143 decreases, so that the hydraulic pressure of the pressurization medium formed in the first pressure chamber 143 increases.

At the same time as the hydraulic piston 142 additionally moves forward, the second valve 152a provided in the second hydraulic flow path 152 is switched to the open state. Accordingly, at the same time as a part of the hydraulic pressure of the pressurization medium formed in the first pressure chamber 143 is secondly transmitted to the wheel cylinder 10 by sequentially passing through the first hydraulic flow path 151 and the third hydraulic flow path 153, the remaining part of the hydraulic pressure of the pressurization medium formed in the first pressure chamber 143 is introduced into the second pressure chamber 144 by sequentially passing through the first hydraulic flow path 151 and the second hydraulic flow path 152. At this time, the dump valve 162a provided in the second dump flow path 162 may be switched to a dosed state to block the flow of the pressurization medium through the second dump flow path 162, and the same time may effectively form a negative pressure in the second pressure chamber 144 to rapidly introduce the pressurization medium transferred along the second hydraulic flow path 152 into the second pressure chamber 144.

As such, although the volume of the flow path in communication with the first pressure chamber 143 or the wheel cylinder 10 momentarily increases as the second valve 152a is open in the second braking mode, the hydraulic pressure value of the pressurization medium may be prevented from momentarily decreasing by additionally moving the hydraulic piston 142 forward. In other words, by supplying a part of the relatively high pressure pressurization medium formed in the first pressure chamber 143 by the additional forward movement of the hydraulic piston 142 to the wheel cylinder 10, a delay in pressurization of the pressurization medium to be provided to the wheel cylinder 10 may be prevented, and the braking force may be prevented from being released (section \textcircled{2} in FIG. 5).

In addition, by supplying the remaining part of the relatively high pressure pressurization medium formed in the first pressure chamber 143 to the second pressure chamber 144, the internal hydraulic pressure values of the first pressure chamber 143 and the second pressure chamber 144 are synchronized to reduce a load applied to the actuator 146. In other words, because the internal hydraulic pressure value of the first pressure chamber 143 increases as the hydraulic piston 142 moves forward, a force to move the hydraulic piston 142 backward increases by the hydraulic pressure in the first pressure chamber 143, and thus the load applied to the actuator 146 increases, but as a part of the hydraulic pressure of the pressurization medium formed in the first pressure chamber 143 is introduced into the second pressure chamber 144 by allowing the flow of the pressurization medium through the second hydraulic flow path 152, the internal hydraulic pressures of the first pressure chamber 143 and the second pressure chamber 144 are synchronized with each other to reduce a load applied to a component such as the actuator 146.

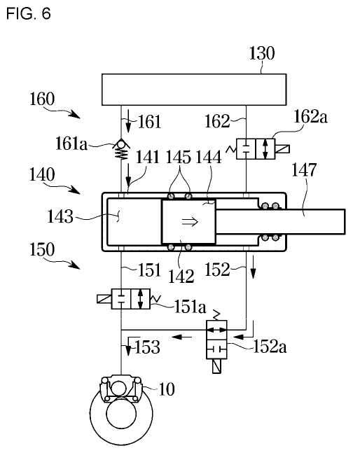

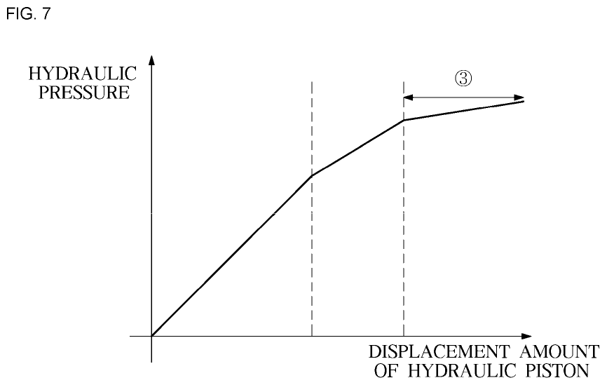

The electronic brake system 100 according to the present embodiment may switch from the second braking mode to the third braking mode illustrated in FIGS. 6 and 7 when a higher braking pressure than in the second braking mode is to be provided.

FIG. 6 is a hydraulic circuit diagram illustrating an operation in which the electronic brake system 100 according to the present embodiment performs the third braking mode, and FIG. 7 is a graph illustrating a change in hydraulic pressure of the pressurization medium to be transmitted to the wheel cylinder 10 depending on a displacement amount of the hydraulic piston 142 in the third braking mode.

Referring to FIGS. 6 and 7, after the second braking mode, the electronic control unit moves the hydraulic piston 142 backward by driving the motor in the other direction when a higher pressure pressurization medium is to be provided. As the hydraulic piston 142 moves backward, the hydraulic pressure of the pressurization medium accommodated in the second pressure chamber 144 gradually increases (section \textcircled{3} in FIG. 7).

The high pressure pressurization medium pressurized in the second pressure chamber 144 is thirdly transmitted to the wheel cylinder 10 by sequentially passing through the second hydraulic flow path 152 and the third hydraulic flow path 153. At this time, the second valve 152a provided in the second hydraulic flow path 152 is controlled in the opened state for smooth flow of the pressurization medium, and the first valve 151a provided in the first hydraulic flow path 151 is controlled in the dosed state, so that the hydraulic pressure of the pressurization medium discharged from the second pressure chamber 144 may be prevented from leaking into the first pressure chamber 143.

In addition, in the third braking mode, the dump valve 162a provided in the second dump flow path 162 is controlled in the dosed state, so that the hydraulic pressure of the pressurization medium formed in the second pressure chamber 144 may be prevented from being discharged to the reservoir 130 through the second dump flow path 162. In addition, the dump check valve 161a provided in the first dump flow path 161 is provided to allow the flow of the pressurization medium from the reservoir 130 toward the first pressure chamber 143, and thus a negative pressure formed in the first pressure chamber 143 as the hydraulic piston 142 moves backward may introduce the pressurization medium of the reservoir 130 into the first pressure chamber 143 through the first dump flow path 161.

The flow of the pressurization medium through the second dump flow path 162 may be allowed. As the hydraulic piston 142 moves forward, the volume of the second pressure chamber 144 increases to form a negative pressure, and the negative pressure may introduce the pressurization medium accommodated in the reservoir 130 into the second pressure chamber 144 through the second dump flow path 162.

As is apparent from the above, an operating method of an electronic brake system according to the present embodiment can stably and effectively perform braking even in various operating situations of a vehicle.

Further, the operating method of the electronic brake system according to the present embodiment can stably generate a high braking pressure.

Further, the operating method of the electronic brake system according to the present embodiment can improve braking performance and operational reliability.

Further, the operating method of the electronic brake system according to the present embodiment can stably provide a hydraulic pressure of a pressurization medium for braking the vehicle.

Further, the operating method of the electronic brake system according to the present embodiment can improve durability of a product by reducing loads applied to components.

What is claimed is:

1. An operating method of an electronic brake system comprising: a hydraulic pressure supply device configured to generate a hydraulic pressure for braking of a wheel cylinder by operating a hydraulic piston by an electrical signal output in response to a displacement of a brake pedal; a reservoir in which a pressurization medium is stored; a dump controller configured to control a flow of the pressurization medium between the reservoir and the hydraulic pressure supply device; and a hydraulic control unit provided between the hydraulic pressure supply device and the wheel cylinder,
wherein the hydraulic pressure supply device comprises a first pressure chamber provided on a front side of the hydraulic piston and a second pressure chamber provided on a rear side of the hydraulic piston, and
wherein the operating method comprises:
a first braking mode in which the hydraulic piston moves forward to firstly provide the hydraulic pressure formed in the first pressure chamber to the wheel cylinder;
a second braking mode in which the hydraulic piston additionally moves forward to secondly provide at least a part of the hydraulic pressure formed in the first pressure chamber to the wheel cylinder and provide the remaining part of the hydraulic pressure formed in the first pressure chamber to the second pressure chamber; and
a third braking mode in which the hydraulic piston moves backward to thirdly provide the hydraulic pressure formed in the second pressure chamber to the wheel cylinder.

2. The operating method according to claim 1, wherein
the hydraulic control unit comprises:
a first hydraulic flow path having one end in communication with the first pressure chamber; a second hydraulic flow path having one end in communication with the second pressure chamber; a third hydraulic flow path to join the other end of the first hydraulic flow path and the other end of the second hydraulic flow path and connected to the wheel cylinder; a first valve provided in the first hydraulic flow path; and a second valve provided in the second hydraulic flow path, and
in the first braking mode, the first valve is opened and the second valve is closed so that the hydraulic pressure formed in the first pressure chamber is provided to the wheel cylinder through the first hydraulic flow path and the third hydraulic flow path.

3. The operating method according to claim 1, wherein
the hydraulic control unit comprises:
a first hydraulic flow path having one end in communication with the first pressure chamber; a second hydraulic flow path having one end in communication with the second pressure chamber; a third hydraulic flow path to join the other end of the first hydraulic flow path and the other end of the second hydraulic flow path and connected to the wheel cylinder; a first valve provided in the first hydraulic flow path; and a second valve provided in the second hydraulic flow path, and
in the second braking mode, the first valve and the second valve are opened so that at least a part of the hydraulic pressure formed in the first pressure chamber is provided to the wheel cylinder through the first hydraulic flow path and the third hydraulic flow path and the remaining part of the hydraulic pressure formed in the first pressure chamber is provided to the second pressure chamber through the first hydraulic flow path and the second hydraulic flow path.

4. The operating method according to claim 1, wherein
the hydraulic control unit comprises:
a first hydraulic flow path having one end in communication with the first pressure chamber; a second hydraulic flow path having one end in communication with the second pressure chamber; a third hydraulic flow path to join the other end of the first hydraulic flow path and the other end of the second hydraulic flow path and connected to the wheel cylinder; a first valve provided in the first hydraulic flow path; and a second valve provided in the second hydraulic flow path, and
in the third braking mode, the second valve is opened and the first valve is closed so that the hydraulic pressure formed in the second pressure chamber is provided to the wheel cylinder through the second hydraulic flow path and the third hydraulic flow path.

5. The operating method according to claim 2, wherein
the dump controller comprises:
a first dump flow path to connect the reservoir and the first pressure chamber; a second dump flow path to connect the reservoir and the second pressure chamber; and a dump valve provided in the second dump flow path, and
in the first braking mode, the dump valve is opened so that the pressurization medium is supplied from the reservoir to the second pressure chamber.

6. The operating method according to claim 3, wherein
the dump controller comprises,
a first dump flow path to connect the reservoir and the first pressure chamber; a second dump flow path to connect the reservoir and the second pressure chamber; and a dump valve provided in the second dump flow path, and
in the second braking mode, the dump valve is closed so that a negative pressure is formed in the second pressure chamber.

7. The operating method according to claim 4, wherein
the dump controller comprises:
a first dump flow path to connect the reservoir and the first pressure chamber; a second dump flow path to connect the reservoir and the second pressure chamber; and a dump valve provided in the second dump flow path, and
in the third braking mode, the dump valve is closed so that the hydraulic pressure formed in the second pressure chamber is blocked from leaking into the reservoir.

8. The operating method according to claim 5, wherein
the dump controller further comprises a dump check valve provided in the first dump flow path, and
in the first braking mode, the dump check valve blocks the hydraulic pressure formed in the first pressure chamber from leaking into the reservoir.

9. The operating method according to claim 6, wherein
the dump controller further comprises a dump check valve provided in the first dump flow path, and
in the second braking mode, the dump check valve blocks the hydraulic pressure formed in the first pressure chamber from leaking into the reservoir.

10. The operating method according to claim 7, wherein
the dump controller further comprises a dump check valve provided in the first dump flow path, and
in the third braking mode, the dump check valve allows supply of the pressurization medium from the reservoir to the first pressure chamber.
